(19) United States
(12) Patent Application Publication
(10) Pub. No.: US 2015/0050141 A1
(43) Pub. Date: Feb. 19, 2015

(54) PASSIVE SHUTDOWN SEALING DEVICE FOR A SHAFT SEALING SYSTEM OF A REACTOR COOLANT PUMP SET

(71) Applicant: AREVA NP, Courbevoie (FR)

(72) Inventor: Eric Savin, Chalon Sur Saone (FR)

(21) Appl. No.: 14/370,311

(22) PCT Filed: Dec. 26, 2012
(86) PCT No.: PCT/EP2012/076912

§ 371 Date: Jul. 2, 2014

(30) Foreign Application Priority Data
Jan. 4, 2012 (FR) 1250087

(51) Int. Cl. F04D 29/12; F04D 7/08; F16J 15/16; F04D 1/00

(52) U.S. Cl. CPC F04D 29/126; F04D 1/00; F04D 7/08; F16J 15/164
USPC 415/230

(57) ABSTRACT

This invention relates to a passive shutdown sealing device (20, 40) for a reactor coolant pump set comprising a set of bimetallic strips (21, 41) having a first position called the cold position when the temperature of said bimetallic strips is less than said temperature threshold, and a second position called the hot position when the temperature of said bimetallic strips is greater than said temperature threshold; a sealing ring (23) with an active position when said bimetallic strips (21, 41) are in their hot position and with an inactive position when said bimetallic strips are in their cold position; locking/unlocking means (25) adapted to lock said sealing ring (23) in its inactive position when said bimetallic strips (21, 41) are in their cold position and to release said sealing ring (23) when said bimetallic strips (21, 41) are in their hot position; elastic means (24) adapted to constrain said sealing ring (23) in the active position when said locking/unlocking means (25) are unlocked.

### TECHNICAL FIELD

The field of the invention is reactor coolant pump set for a nuclear pressurised water reactor (PWR).

The invention is more particularly applicable to a passive shutdown sealing device (SSD) used to control a primary coolant leak resulting from a failure of the sealing system present on the reactor coolant pump set.

### STATE OF THE ART

Shutdown sealing devices (SSD) have been developed in new generation nuclear pressurised water reactors to handle a failure of the reactor coolant pump set sealing system following an accident situation called SBO (Station Black Out).

Thus, shutdown sealing devices must be capable of controlling and stopping a primary coolant leak resulting from a failure of the reactor coolant pump set sealing system in this accident situation and after the reactor coolant pump set has been shut down.

Conventionally, this type of device is activated by an auxiliary source (for example such a pressurised nitrogen circuit) and triggering is controlled by information output by the reactor instrumentation control if the reactor coolant pump set cooling sources are lost.

A passive shutdown sealing device has been developed that does not require any auxiliary activation system or the generation of triggering information in the reactor instrumentation control, in order to avoid the use of an activation source. Such a passive shutdown sealing system is disclosed in document WO 2010/068615.

### PRESENTATION OF THE INVENTION

In this context, the invention is aimed at proposing an improving to such a sealing device in order to guarantee activation of the sealing device and correct operation during an accident situation.

To achieve this, the invention discloses a passive shutdown sealing device for a reactor coolant pump set shaft sealing system comprising at least one bimetallic strip adapted to change shape starting from a temperature threshold; said bimetallic strip has a first position called the cold position when the temperature of said bimetallic strip is less than said temperature threshold, and a second position called the hot position when the temperature of said bimetallic strip is greater than said temperature threshold;

said device being characterised in that it comprises:
a sealing ring with an active position when said at least one bimetallic strip is in its hot position and with an inactive position when said at least one bimetallic strip is in its cold position;
locking/unlocking means fixed to said at least one bimetallic strip and adapted to lock said sealing ring in its inactive position when said at least one bimetallic strip is in its cold position and to release said sealing ring when said at least one bimetallic strip is in its hot position;
elastic means adapted to constrain said sealing ring in the active position when said locking/unlocking means are unlocked.

With the invention, it is possible to stop a leak of the primary coolant resulting from a failure of the reactor coolant pump set sealing system without requiring an auxiliary activation source.

The design of the device according to the invention enables a simplified installation on architectures of reactor coolant pump sets already in service.

With the device according to the invention, it is also possible to adjust the device to operating constraints of each type of nuclear reactor by adjusting the self-activation temperature of the device and more precisely by modifying the temperature threshold at which the bimetallic strip changes shape.

The passive shutdown sealing device according to the invention may also have one or several of the following characteristics taken individually or in any technically possible combination:
said device is adapted to be integrated on a shaft sealing system of a reactor coolant pump set in service;
said ring comprises a shoulder adapted to cooperate with said locking/unlocking means;
said at least one bimetallic strip is adapted to change shape starting from a temperature threshold of between 80° C. and 200° C., advantageously equal to 150° C.;
said sealing ring is made from a polymer material resistant to temperatures exceeding 300° C.;
said sealing ring is made of PEEK;
said sealing ring is made of a composite made from a PEEK matrix filled with glass or carbon fibres;
said sealing ring is made from a metallic material;
said sealing ring is a composite material formed by a metallic core and coated by a material more malleable than said metallic core;
said material more malleable than said metallic core is a polymer or nickel or silver;
said elastic means are compression springs;
the device comprises a plurality of bimetallic strips and a plurality of locking/unlocking means distributed around said ring; said bimetallic strips and said locking/unlocking means being at a constant angular distance from each other;
said device comprises three bimetallic strips and three locking/unlocking means.

Another purpose of the invention is a reactor coolant pump set comprising:
a sealing system adapted to set up a controlled leak along a leakage path arranged along the reactor coolant pump set shaft;
a passive shutdown sealing device according to the invention adapted to at least partially close off said leakage path of said sealing system when said sealing system is defective and when said sealing ring is active, so as to create a controlled leak.

### BRIEF DESCRIPTION OF THE DRAWINGS

Other characteristics and advantages of the invention will become clearer after reading the following description given for guidance and in no way limitative, with reference to the appended drawings among which:

FIG. 1 shows a first embodiment of a passive shutdown sealing device according to the invention integrated into a reactor coolant pump set sealing system;

FIGS. 2a and 2b show the behaviour of the passive shutdown sealing device shown in FIG. 1 as a function of the temperature;

FIG. 3 shows a second embodiment of a passive shutdown sealing device according to the invention integrated into a reactor coolant pump set sealing system:

FIGS. 4a and 4b show the behaviour of the shutdown sealing device shown in FIG. 3 as a function of the temperature.

Identical or similar elements are marked by identical reference marks in all figures, to improve clarity.

### DETAILED DESCRIPTION OF AT LEAST ONE EMBODIMENT

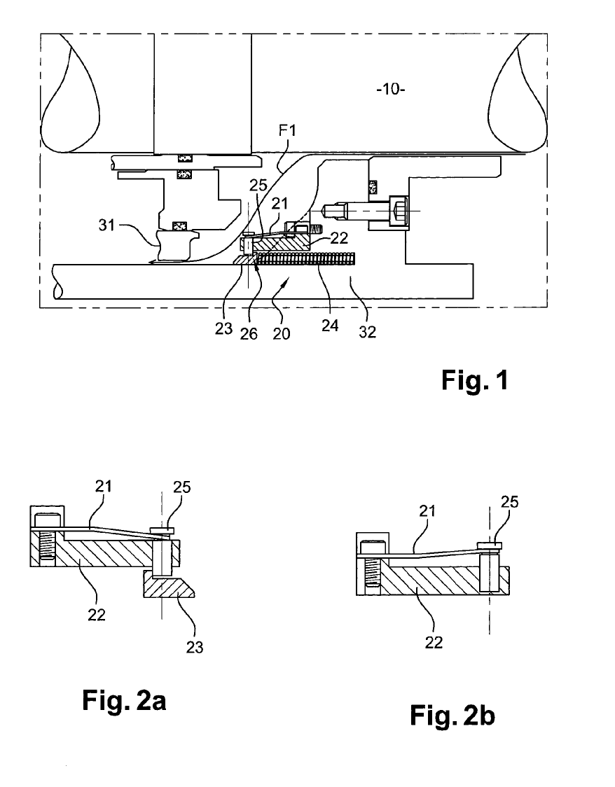

The reactor coolant pump sets of pressurised water reactors are centrifugal type pumps with vertical axis. The dynamic seal at the shaft outlet 10 (FIG. 1) is provided by a sealing system composed of three stages.

The first stage is called seal No. 1. Seal No. 1 (not shown) is a controlled leak hydrostatic seal. During normal operation, a leakage flow shown by arrow F1 is set up along the shaft 10.

In an accident situation, the fluid temperature at the inlet to seal No. 1 increases quickly to reach a value close to the temperature of the primary circuit, which is about 280° C. The performances of seal No. 1 are degraded at this temperature, which results in a very large increase in the leakage flow that may exceed 10 m³ per hour. The passive shutdown sealing devices (SSD) will block the leakage path F1 on the downstream side of seal No. 1 in this accident situation.

FIG. 1 shows a first embodiment of a passive shutdown sealing device according to the invention integrated into a reactor coolant pump set sealing system. The SSD device shown in FIG. 1 is shown under normal operating conditions. FIGS. 2a and 2b show a sectional view of two states of the sealing device according to the invention.

FIG. 2a more particularly shows the sealing device under normal operating conditions of the reactor coolant pump set, in other words when the temperature of the device is less than a threshold value.

FIG. 2b more particularly shows the sealing device during accident operating situations of the reactor coolant pump set, in other words when the temperature of the device is higher than a threshold value.

The shutdown sealing device 20 according to the invention comprises:
a plurality of bimetallic strips 21 (only one being shown) adapted to change shape starting from a predetermined temperature threshold;
a support 22 to fix the device 20 to the reactor coolant pump set, and more particularly to the floating assembly support 32 of seal No. 1;
a sealing ring 23 positioned concentric with the pump shaft 10 of the reactor coolant pump set;
elastic means 24 such as compression springs adapted to move the sealing ring in the axial direction and to hold seal No. 2 on the rotating surface 31;
locking/unlocking means 25 for locking or unlocking the inactive position of the sealing ring 23.

In the first embodiment shown in FIGS. 1, 2a and 2b, the bimetallic strips 21 are in the shape of a fork fixed at one of its ends onto the support 22 by screwing means.

At its free end, the bimetallic strip 21 is fixed to the locking/unlocking means 25. The locking/unlocking means 25 are advantageously pins.

The support 22 comprises through reamings into which the pins 25 are inserted and open up on each side of the support 22 so that they can cooperate with the sealing ring 23. The pins 25 are installed free to slide inside the reamings so that can displace in their axial direction when the bimetallic strips 21 change shape when the leakage flow temperature increases.

According to one preferred embodiment of the invention, the device comprises three bimetallic strips 21 distributed at 120° around the circumference of the reactor coolant pump set shaft 10.

Under normal operating conditions (FIGS. 1 and 2a), the bimetallic strip 21 is in its cold position, the leakage flow temperature being less than the threshold shape change temperature.

Under these conditions, the sealing ring 23 is locked in an inactive position as shown in FIG. 1 or FIG. 2a, by cooperation of a shoulder 26 located on the inside peripheral part of the ring and the pins 25 and by tensioning of the ring 23 on the pin 25 by compression of elastic means.

Under accident conditions (FIG. 2b), the increase in the temperature of the leakage flow increases the temperature of the bimetallic strip 21 that then changes shape when the bimetallic strip reaches its shape change threshold temperature. Thus in this situation, the bimetallic strip “toggles”. Toggling of the bimetallic strip 21 modifies the position of the pin 25, fixed to the bimetallic strip 21, so as to make it slide in the reaming of the support 22 and release it from the shoulder 26 of the sealing ring 23. Since the sealing ring 23 is no longer axially constrained by the pins 25, the elastic means 24 bring the ring 23 into contact with the rotating surface 31 of seal No. 2, thus blocking the leakage path symbolised by the arrow reference F1. The sealing ring 23 is guided along the axial direction by its outside diameter inside the reaming of the part 32 supporting the floating assembly of seal No. 1.

The sealing ring 23 is blocked in the active position, in other words in contact with the rotating surface 31, initially by elastic means 24 and then also by an autoclave effect induced by the increase of the pressure on the upstream side of device 20.

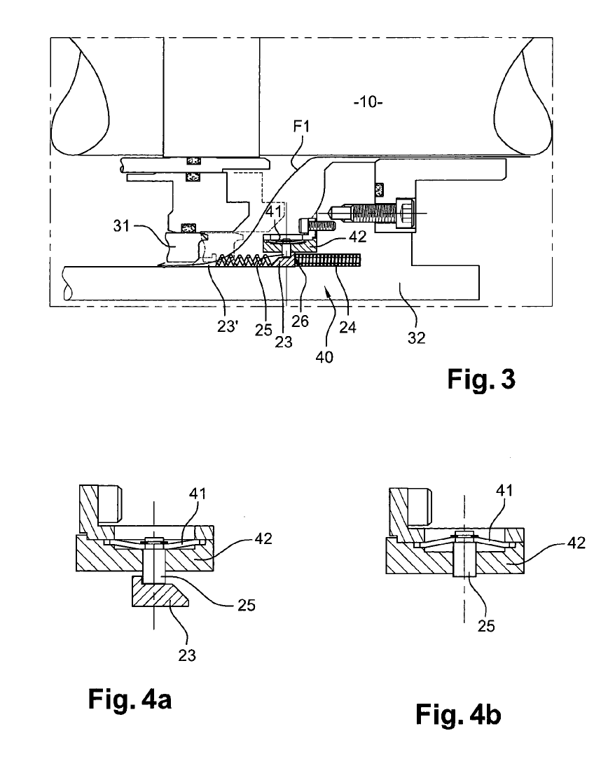

FIG. 3 shows a second embodiment of a passive shutdown sealing device according to the invention integrated into a reactor coolant pump set sealing system. The SSD device shown in FIG. 3 is illustrated under normal operating conditions, with the position of the sealing means 23′ under accident conditions. FIGS. 4a and 4b show a sectional view of two states of the sealing device according to the second embodiment shown in FIG. 3.

FIG. 4a more particularly shows the second embodiment of the sealing device during normal operating conditions of the reactor coolant pump set, in other words when the temperature of the device is less than a threshold value.

FIG. 4b more particularly shows the second embodiment of the sealing device under accident operating situations of the reactor coolant pump set, in other words when the temperature of the device is higher than a threshold value.

The shutdown sealing device 40 comprises:
a plurality of bimetallic strips 41 adapted to change shape starting from a predetermined temperature threshold;
a support 42 to fix the device on the reactor coolant pump set, and more precisely on the support of the floating assembly 32 of seal No. 1;
a sealing ring 23;
elastic means 24 such as compression springs adapted to move the sealing ring in the axial direction and to hold it on the rotating surface 31 of seal No. 2;
locking/unlocking means 25 for locking or unlocking the inactive position of the sealing ring 23.

In this second embodiment, the bimetallic strip 41 is in the shape of a disk blocked at its outside diameter by the support 42.

The disk shaped bimetallic strip comprises a perforation at its centre that will be used to fix the locking/unlocking means 25.

The support 42 comprises through reamings into which the locking/unlocking means 25 are inserted and open up on each side of the support 42 so that they can cooperate with the sealing ring 23.

In the same way as the embodiment described above, the locking/unlocking means 25 are mounted free to slide inside the reamings so that they can displace in the axial direction when the bimetallic strips 41 change shape due to the increase in the leakage flow temperature.

Under normal operating conditions (FIGS. 3 and 4a), the bimetallic strip 41 is in its cold position, the leakage flow temperature being less than the temperature of the shape change threshold.

Under these conditions, the sealing ring 23 is locked in an inactive position by cooperation of a shoulder 26 located on the inside peripheral part of the ring and locking/unlocking means 25. Thus in this rest position, i.e. during normal operation, the sealing ring 23 is held locked in this position and the elastic means 24 are compressed.

Under accident conditions (FIG. 4b), the increase in the leakage flow temperature effectively increases the temperature of the bimetallic strip 41 that then changes shape when the bimetallic strip reaches its shape change threshold temperature. Thus in this situation, the bimetallic strip “toggles”. Toggling of the bimetallic strip 41 changes the position of the locking/unlocking means 25 to make it slide in the reaming of the support 42 and to release it from the shoulder 26 of the sealing ring 23. Since the sealing ring 23 is not longer held in place axially by the locking/unlocking means 25, the compressed elastic means 24 apply an axial force on the ring 23 thus bringing it into contact with the rotating surface 31 of seal No. 2, thus blocking the leakage path symbolised by the arrow reference F1.

The sealing ring 23 is blocked in the active position (shown by reference 23′ in FIG. 3), in other words in contact with the rotating surface 31, by elastic means 24 and by the autoclave effect induced by the increase in pressure on the upstream side of the device 20.

The bimetallic strip 21, 41 of the sealing device according to the invention is made such that it has a toggle temperature threshold of between 80° C. and 200° C. and advantageously equal to 150° C.

The sealing ring 23 of the device 20 or 40 may be made from a polymer material resistant to high temperatures (i.e. more than 300° C.), for example such as PEEK or a composite of PEEK filled with glass or carbon fibres. The use of such a material makes it possible to obtain a sealing ring in a rubbery state at high temperature so that it can deform to match the geometry of the rotating surface of seal No. 2 and thus give a better sealing quality.

The sealing ring 23 of the device 20 or 40 may also be made from a metallic material. In this case, a residual leakage flow will be expected due to the existing clearances between the sealing ring 23 and the parts in contact with it. However, the use of a metallic material can make the device and particularly the sealing ring more secure if said device is activated before the pump shaft has completely stopped turning.

The sealing ring 23 may also be made from a composite material formed from a metallic core coated with a material more malleable than the core, for example such as a polymer, nickel or silver. The peripheral material more malleable than the core can fill in existing clearances between the different parts by deformation of the surface layer. If the surface layer is worn caused by rotation of the shaft, this denser metallic core can guarantee a limitation of the leakage flow.

1. A passive shutdown sealing device for a reactor coolant pump set shaft sealing system comprising at least one bimetallic strip adapted to change shape starting from a temperature threshold; said bimetallic strip having a first position called the cold position when the temperature of said bimetallic strip is less than said temperature threshold, and a second position called the hot position when the temperature of said bimetallic strip is greater than said temperature threshold;
wherein said device comprises:
a sealing ring with an active position when said at least one bimetallic strip is in its hot position and with an inactive position when said at least one bimetallic strip is in its cold position;
locking/unlocking means fixed to said at least one bimetallic strip and adapted to lock said sealing ring in its inactive position when said at least one bimetallic strip is in its cold position and to release said sealing ring when said at least one bimetallic strip is in its hot position;
elastic means adapted to constrain said sealing ring in the active position when said locking/unlocking means are unlocked.

2. The passive shutdown sealing device for reactor coolant pump set shaft sealing system according to claim 1, wherein said device is adapted to be integrated on a shaft sealing system of a reactor coolant pump set in service.

3. The passive shutdown sealing device for reactor coolant pump set shaft sealing system according to claim 1, wherein said sealing ring comprises a shoulder adapted to cooperate with said locking/unlocking means.

4. The passive shutdown sealing device for reactor coolant pump set shaft sealing system according to claim 1, wherein said at least one bimetallic strip is adapted to change shape starting from a temperature threshold of between 80° C. and 200° C.

5. The passive shutdown sealing device for reactor coolant pump set shaft sealing system according to claim 1, wherein said sealing ring is made from a polymer material resistant to temperatures exceeding 300° C.

6. The passive shutdown sealing device for reactor coolant pump set shaft sealing system according to claim 5, wherein said sealing ring is made of PEEK.

7. The passive shutdown sealing device for reactor coolant pump set shaft sealing system according to claim 5, wherein said sealing ring is a composite made from a PEEK matrix filled with glass or carbon fibres.

8. The passive shutdown sealing device for reactor coolant pump set shaft sealing system according to claim 1, wherein said sealing ring is made from a metallic material.

9. The passive shutdown sealing device for reactor coolant pump set shaft sealing system according to claim 1, wherein said sealing ring is a composite material formed by a metallic core and coated by a material more malleable than said metallic core.

10. The passive shutdown sealing device for reactor coolant pump set shaft sealing system according to claim 9, wherein said material more malleable than said metallic core is a polymer or nickel or silver.

11. The passive shutdown sealing device for reactor coolant pump set shaft sealing system according to claim 1, wherein said elastic means are compression springs.

12. The passive shutdown sealing device for reactor coolant pump set shaft sealing system according to claim 1, comprises comprising a plurality of bimetallic strips and a plurality of locking/unlocking means distributed around said sealing ring (23), said bimetallic strips and said locking/unlocking means being at a constant angular distance from each other.

13. The passive shutdown sealing device for reactor coolant pump set shaft sealing system according to claim 1, comprising three bimetallic strips and three locking/unlocking means.

14. A reactor coolant pump set comprising:
a sealing system adapted to set up a controlled leak along a leakage path arranged along the reactor coolant pump set shaft;
a passive shutdown sealing device according to one of the previous claims adapted to at least partially close off said leakage path of said sealing system when said sealing system is defective and when said sealing ring is active, so as to create a controlled leak.

15. The passive shutdown sealing device for reactor coolant pump set shaft sealing system according to claim 4 wherein said at least one bimetallic strip is adapted to change shape at a temperature threshold of about 150° C.
